(19) United States
(12) Patent Application Publication
(10) Pub. No.: US 2007/0070254 A1
(43) Pub. Date: Mar. 29, 2007

(54) Video standard determination

(76) Inventors: Robert P. Cazier, Fort Collins, CO (US); Christopher Webb, Wellington, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/235,994

(22) Filed: Sep. 26, 2005

(51) Int. Cl. H04N 5/38

(52) U.S. Cl. 348/723

(57) ABSTRACT

Various embodiments for determining a correct video standard for a display device (e.g., a television monitor) are described. In an embodiment, a test signal in accordance with a video standard is transmitted to the display device. One or more signals transmitted by the display device are analyzed to determine whether the video standard is a correct video standard for the display device.

### BACKGROUND

The present description generally relates to video standard determination. More particularly, an embodiment relates to determining a correct video standard for a display device (e.g., a television monitor).

Different video standards are used around the world for broadcasting television signals. For example, television broadcasts in the United States of America are in NTSC (National Television System Committee) format. In some of Europe, television programming is broadcast in PAL (phase alternation line) format. Other parts of the world (such as France and portions of the Middle East) may use SECAM (sequential color and memory) format to broadcast television programs.

Some digital cameras are capable of displaying captured images on a regular television set. For example, a digital camera may be connected to a television set via a cable. However, to correctly display an image on a television set, a user needs to determine the video standard of the television set and then configure the camera appropriately. These steps may require the user to search through the manual and/or camera menus to try to find the correct setting.

One approach attempts to determine the video standard of the television receiver based on region and/or language settings provided by a user. However, such an approach may result in an incorrect video standard setting. For example, a user may pick Spanish as the language for the camera menus and South America as the region where the user is located. Since Spanish speaking countries in South America use various video standards, these inputs may result in an incorrect video standard setting. Accordingly, the user may need to search through the manual and/or camera menus to try and find the correct setting.

### BRIEF DESCRIPTION OF DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates various components of a system which may be utilized to implement portions of the techniques discussed herein, according to an embodiment.

FIG. 2 illustrates various components of a digital camera, according to an embodiment.

FIG. 3 illustrates a flow diagram of a method for determining a correct video standard setting of a display device, according an embodiment.

FIG. 4 illustrates various components of a computing device which may be utilized to implement portions of the techniques discussed herein, according to an embodiment.

### DETAILED DESCRIPTION

Various embodiments for determining a correct video standard for a display device (e.g., a television monitor) are described. In one embodiment, a test signal is transmitted to the display device in accordance with a video standard (such as NTSC, PAL, SECAM, or their varieties). The display device generates one or more displays in response to the test signal. A generated display may be thought of as a signal transmitted by the display device. Thus, it may be said that the display device transmits one or more signals in response to receiving a test signal. The signal(s) transmitted by the display device are analyzed to determine whether the video standard corresponding to the test signal is a correct video standard for the display device.

Moreover, the device that is transmitting the signals to the display device may be any suitable device capable of accessing data such as image, audio, or video data. For example, the device may be a digital camera (e.g., capable of capturing still images or video streams in digital format), personal digital assistant (PDA), cellular phone, MPEG (Moving Picture Experts Group) player (such as MPEG4 for compressed video streams), MP3 (MPEG layer-3 audio) player, or combinations thereof.

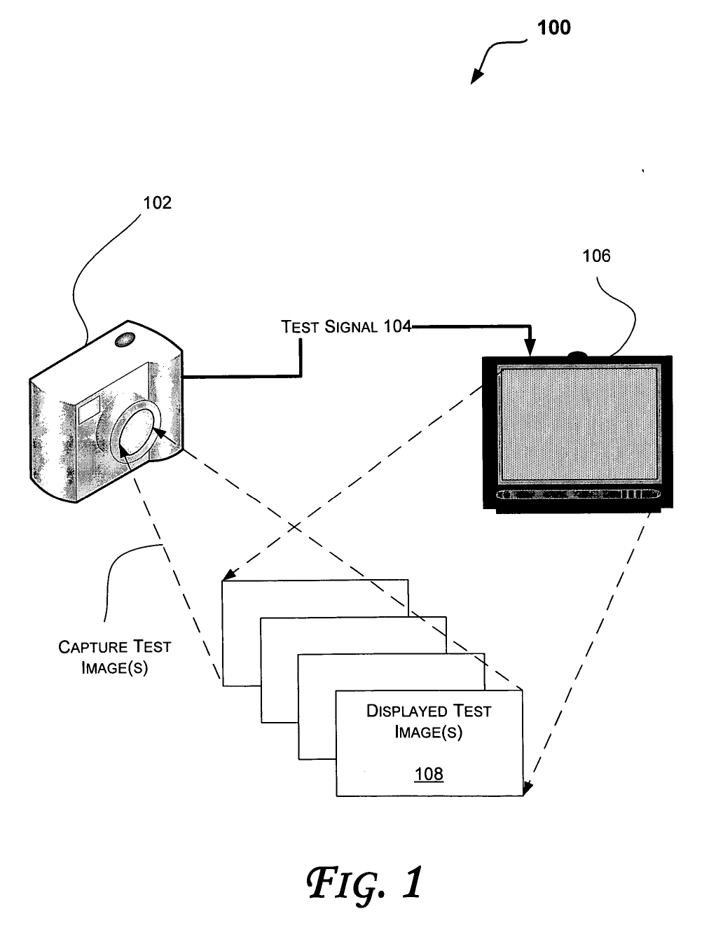

FIG. 1 illustrates various components of a system 100 which may be utilized to implement portions of the techniques discussed herein, according to an embodiment. The system 100 includes a digital camera 102. The digital camera 102 may be any suitable image capture device that is capable of capturing images in digital format. The camera 102 may be a stand-alone camera or a camera incorporated into another device (such as a PDA, a cellular phone, MPEG/MP3 player, or the like).

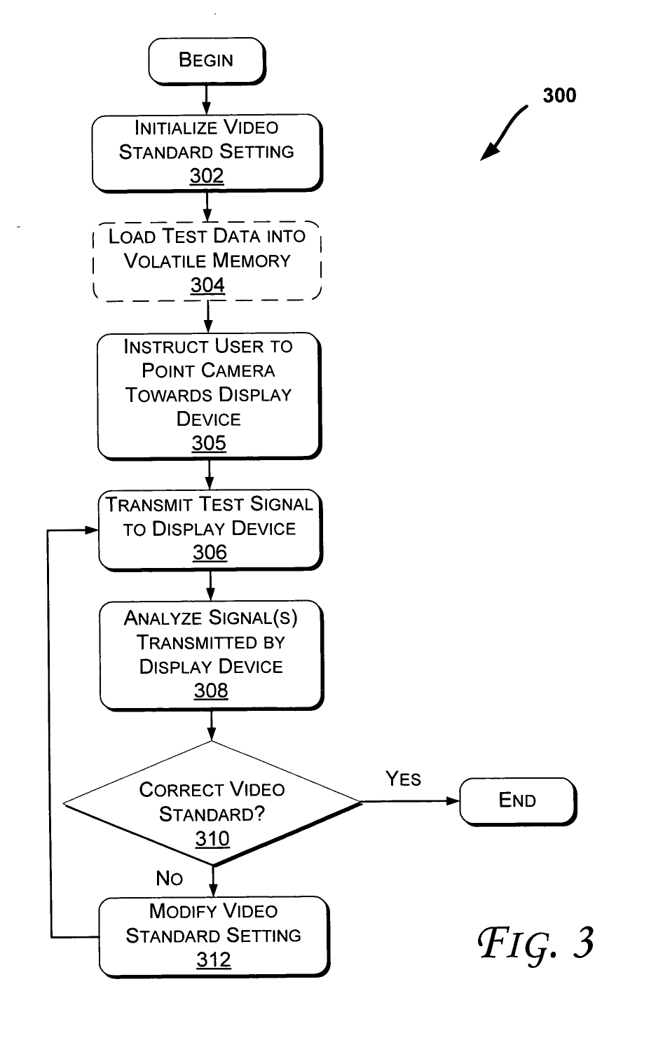

As will be further discussed herein, for example with reference to FIG. 3, the camera 102 may send a test signal 104 to a display device 106 (e.g., a television monitor) via a wired coupling or wirelessly. The display device 106 may display one or more images (108) in accordance with the test signal 104. These displayed test images (108) may be captured by the camera 102 and analyzed to determine the correct video standard setting of the display device 106, as discussed in more detail with reference to FIG. 3.

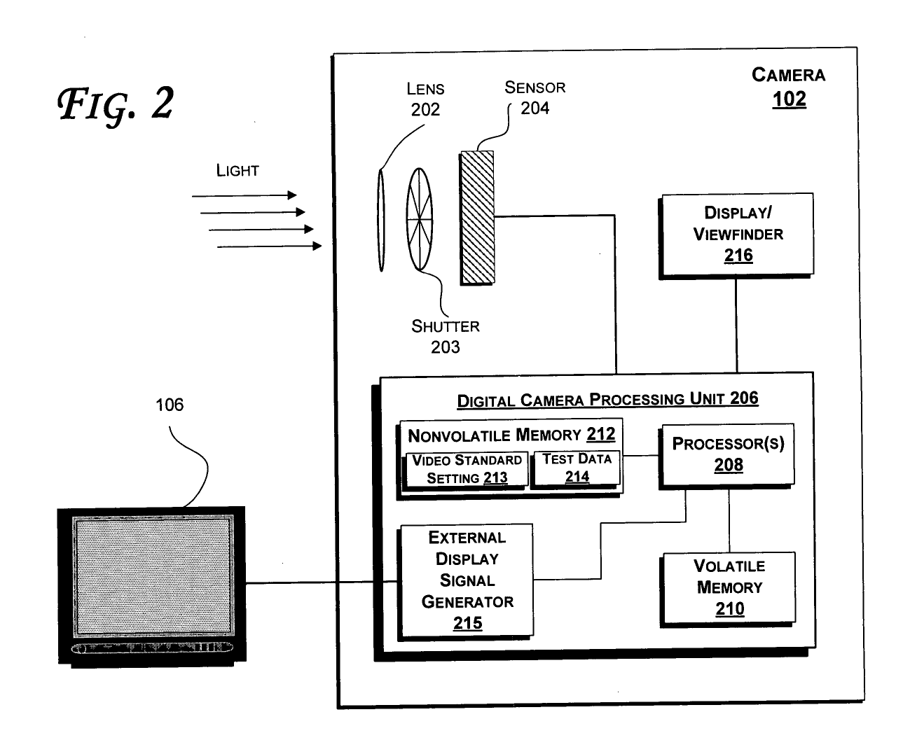

FIG. 2 illustrates various components of the digital camera 102 of FIG. 1, according to an embodiment. The camera 102 includes a lens 202 that is exposed to light rays. Multiple lens configurations may be utilized to capture the light rays such as different types of lenses (e.g., zoom, fish eye, wide angle, etc.). The camera 102 may further include a shutter 203. The shutter 203 may control exposure of a sensor 204 to the light rays passing through the lens 202. As illustrated in FIG. 2, the shutter 203 may be located between the sensor 204 and the lens 202. The shutter 203 may be activated by a button on the camera or remotely (e.g., by an infrared or radio frequency remote control).

The sensor 204 may be any suitable image capture sensor such as a complimentary metal-oxide semiconductor (CMOS) or a charge-coupled device (CCD). In an embodiment, the sensor 204 may be selectively activated or exposed to light rays without utilizing a physical barrier (such as the shutter 203). Moreover, a more simplified mechanism (such as a sensor cover) may be utilized to protect the lens 202 and/or the sensor 204 from environmental elements (e.g., sun rays, dust, water, humidity, or the like).

The digital camera 102 further includes a digital camera processing unit 206 that is coupled to the sensor 204. The processing unit 206 may process various data and/or signals within the camera 102. The processing unit 206 may include one or more processors (208) coupled to a volatile memory 210. The volatile memory 210 may be accessed by the processors 208 to fetch or store data such as configuration data utilized during the operation of the digital camera 102 (such as camera settings) or the like. The volatile memory 210 may further be utilized to temporarily store and/or process data such as images captured by the sensor 204. The volatile memory 210 may include any suitable types of memory such as random access memory (RAM), dynamic RAM (DRAM), synchronous DRAM (SDRAM), static RAM (SRAM), combinations thereof, or the like.

As shown in FIG. 2, the processing unit 206 may include nonvolatile memory 212, such as read-only memory (ROM), erasable programmable ROM (EPROM), electrically erasable programmable ROM (EEPROM), a hard disk drive, or the like. In one embodiment, the EEPROM may be flash memory, which is a form of EEPROM that allows multiple memory locations to be erased or written in one programming operation. The data stored on the nonvolatile memory 212 may be utilized to provide configuration data (such as camera settings including video standard setting 213 and/or test data 214), boot data, or the like.

The processing unit 206 may also include an external display signal generator 215 that is coupled to the processor(s) 208. For example, the processor(s) 208 may retrieve data from the nonvolatile memory 212 and/or volatile memory 210 regarding test signals (e.g., test data 214) and forward the test data to the external display signal generator 215 for conversion into a signal format that is appropriate for the display device 106. In an embodiment, the signal generator 215 may include a digital-to-analog (D/A) signal converter. Also, the signal generated by the signal generator 215 may be in accordance with various standards such as S-Video (separated video), composite video, component video (e.g., utilized with high definition television (HDTV)), VGA (video graphics array, or its varieties such as SVGA (super VGA), etc.), or the like.

The camera 102 may also include a display (such as a liquid crystal display (LCD)) or viewfinder 216 (or both), e.g., to display various information for a user such as camera menus, camera settings, instructions, captured images, vision field, or the like. The camera 102 may further include various input devices (not shown) such as buttons, dials, touch pads, keypad, touch screens, or the like to enable a user to provide input data, for example, in response to the displayed information on the display/viewfinder 216.

Furthermore, the digital camera 102 may include other removable/non-removable, volatile/nonvolatile computer storage media (not shown). By way of example, the nonvolatile memory 212 may include one or more of the following: a floppy disk, an optical disk drive (such as a compact disc ROM (CD-ROM) and/or digital versatile disk (DVD)), a tape (e.g., in case of digital video cameras), or the like.

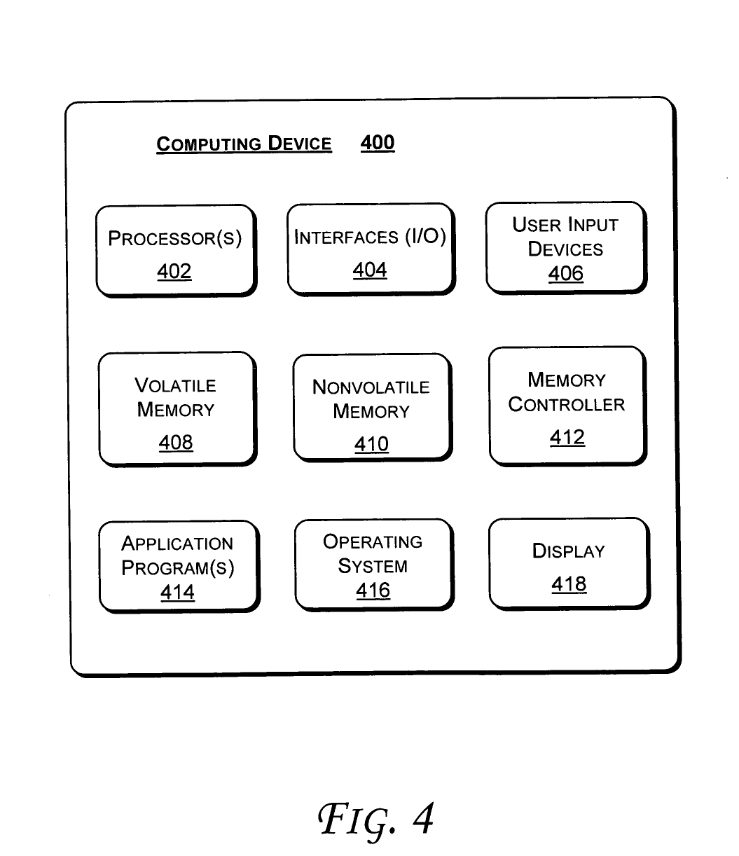

In an embodiment, the digital camera 102 may utilize one or more external facilities (such as the computing device discussed with reference to FIG. 4) to process and/or store data instead of or in addition to the digital camera processing unit 206. In such an embodiment, the digital camera 102 may also be controlled by the external facility. This embodiment may free a photographer from manually modifying the camera parameters between shots, enabling the photographer to focus on capturing images. Furthermore, data may be exchanged with the external facility through a wired connection (e.g., universal serial bus (USB), Fire Wire (e.g., Institute of Electrical & Electronics Engineers (IEEE) 2394 or the like) and/or wireless connection (e.g., IEEE 802.11 (and its varieties), cellular network, radio frequency, etc.).

FIG. 3 illustrates a flow diagram of a method 300 for determining a correct video standard setting of a display device, according an embodiment. In one embodiment, the method 300 may determine the correct video standard for the display device 106 discussed with reference to FIGS. 1-2. The operations of the method 300 may be performed by hardware, software, firmware, or combinations thereof. For example, various components discussed with reference to FIGS. 1, 2, and 4 may perform one or more operations of the method 300. Furthermore, the method 300 may be applied in various devices such as digital cameras, PDAs, cellular phones, MPEG/MP3 players, combinations thereof, or the like.

Referring to FIGS. 1-3, the method 300 starts by initializing the video standard settings of the camera 102. For example, the video standard setting 213 may be initialized to the most probable output based on language, date/time format, language setting, region, etc. The camera 102 (e.g., the processor(s) 208) may optionally load (304) test data 214 stored in the nonvolatile memory 212 into the volatile memory 210, e.g., to improve performance. The test data 214 may be used to generate the test signal 104 (e.g., by the signal generator 215).

At an operation 305, the camera user may be instructed to point the camera 102 towards the display device 106, e.g., by displaying a message on the display/viewfinder 216. In an embodiment, the user may be asked to confirm, e.g., via pressing a button, that the camera 102 is in fact pointed towards the display device 106. Also, the camera 102 may fire a strobe to get the user's attention. In one embodiment, the camera 102 may transmit a strobe signal and capture one or more images to confirm whether the camera is pointed towards the display device 106, e.g., by considering the number of saturated (e.g., white) pixels coming back to the camera 102 to determine how much of the display device fills the sensor 204.

At an operation 306, the test signal 104 is transmitted to the display device 106. In response to the transmitted test signal 104, the display device 106 may transmit one or more signals (e.g., one or more video frames or images) in accordance with the test signal 104 received by the display device 106. At an operation 308, the signals transmitted by the display device 106 are analyzed. For example, images (108) transmitted by the display device 106 may be captured by the sensor 204 and converted into electrical signals for processing by the processing unit 206. Various techniques may be utilized to perform the operation 308, such as analyzing one or more of a normalized histogram, a frequency response, and/or a contrast of the one or more signals transmitted by the display device, which will be further discussed below.

At an operation 310, it is determined whether the video standard corresponding to the transmitted test signal of the operation 306 is correct, e.g., based on the analysis of the operation 308 and comparison of the test signal 104 and the signals transmitted by the display device 106. If the video standard setting is correct, the method 300 terminates. Optionally, the user may be asked to confirm that the video standard setting is correct. Also, the video standard setting 213 may be stored in nonvolatile memory 212 (which is optional in one embodiment, as the operation 302 may have performed this task before). Otherwise, if the operation 310 determines that the video standard setting is incorrect, the video standard setting is modified (312) and the method 300 resumes at the operation 306. In one embodiment, the video standard setting may be modified to the remaining varieties of the current video standard setting prior to switching to a totally different video standard. For example, the processor(s) may modify the video standard setting 213 at the operation 312 from PAL to PAL-M and/or PAL-N, prior to switching to NTSC or SECAM.

As discussed above, various techniques may be utilized to perform the operation 308, such as analyzing one or more of a normalized histogram, a frequency response, and/or a contrast of the one or more signals transmitted by the display device and captured by the camera 102. Each of these techniques will now be discussed in further detail.

The camera 102 may capture data in a prescribed form. Typically, the captured data may encompass some known filter pattern (e.g., a Bayer pattern). This pattern will allow red, green, and blue triplets to be developed for the imaging array (or some alternated form such as YCbCr). In an embodiment, the Bayer pattern may be transformed into an array of x mega pixels based on the image captured by the camera 102. Within the captured image(s) there may be a test pattern or signal (or not). The test signal may then be recognizable. If the captured images of the display device 106 are not recognizable or do not include sufficient color information, then an alternate signal may be generated by the processing unit 206.

For example, the pixels may be read off of the sensor 204 into memory (210). The test pattern (214) which is being generated from memory may be compared to this captured image. In an embodiment, the color space may be irrelevant (YCbCr or RGB or other). The captured image(s) (108) and the test data (214) may be made similar enough for more efficient comparison. Moreover, in order to determine statistically that a pattern has been matched, the color for the image or a subset of the image may be developed and statistically analyzed. In one embodiment, a normalized histogram may be used to determine whether the image has the prescribed color. Further the entire resolution of the sensor 204 need not be used. In fact, just like preview in the camera, a down-sampled version may be used that is smaller than the maximum pixel count of the sensor (VGA resolution instead of 5 mega pixels).

In another embodiment, a relatively saturated blue background may be placed behind a saturated red “+” sign or other shape (geometric or otherwise). Statistically, a certain ratio of blue pixels to red pixels may be detected. This data may be normalized. Generally, normalizing may mean that based on the number of blue pixels detected, a certain number of red pixels should also be detected. Both the lack of color and the “scrolling” because of the differing frequency of the video standards may cause this measurement to be in error.

Furthermore, the test signals (104) instead of being a single pattern may be full screens of red, green, and/or blue. Each screen may be displayed in succession on the display device 106. The captured pixels may be analyzed at operation 308 to determine if the colors have high counts of red, green, and/or blue, respectively. In an embodiment, the Bayer pattern may not need to be demosaiced for the techniques discussed with reference to the operation 308 since the pattern on a sensor (204) typically resembles the following (where R=red, G=green, B=blue):

RGRGRGRG . . . <- row 1
GBGBGBGB . . . <- row 2

The pixel count is generated by interpolating the “other” colors for the pixel. For example, the upper left R pixel will have captured the R information. In order to generate the G and the B information for the final image, the surrounding pixels may be analyzed and interpolated. This process is generally referred to as “demosaicing.” This may speed up the analysis at the operation 308.

In one embodiment, the camera 102 may be used as an oscilloscope to analyze the frequency response of the signals transmitted by the display device 106. For example, the camera 102 may be set to PAL and coupled to an NTSC television (106) with the test signal generating a white screen on the display device 106. Because the PAL pattern has a frequency of 50 Hz, if the camera 102 is used to sample the displayed image(s) 108 at 50 Hz, the same normalized histogram may be perceived by the analysis over time. If the normalized histogram varies (e.g., where a high white count/low white count/high white count sequence occurs), the sampling frequency may be switched to 60 Hz. This may provide a captured sequence of n white count/n white count/n white count etc. which indicates that NTSC will provide a correct video standard for this example. There may be some predefined variation based on monitor/hand shake and other factors that may be factored out based on building in threshold factors. Because the signals are quite a bit different in frequency, the threshold factor may be an estimate.

In a further embodiment, text recognition (or pattern recognition) may be utilized, e.g., by displaying a test image that includes certain text (or pattern). The captured images may be analyzed at the operation 308 to determine the presence of the text in the displayed images 108.

In yet another embodiment, the operation 308 may be performed by contrast analysis. For example, a test signal (104) that generates a grid of two colors may be transmitted at the operation 306, e.g., with saturated blue lines with a red background. The contrast analysis may then be performed by a summation of the transitions between reds and blues. If the signal transmitted by the display device (108) is incorrect, the counts and values will get degraded, e.g., fewer transitions would be present and the sum would be much less than the sum corresponding to the test signal 104. Several images may be captured and averaged to help with deviations.

FIG. 4 illustrates various components of a computing device 400 which may be utilized to implement portions of the techniques discussed herein, according to an embodiment. In one embodiment, the computing device 400 may be used to provide the digital camera processing unit 206 of FIG. 2 and/or perform one or more of the operations of the method 300 of FIG. 4.

As shown in FIG. 4, the computing device 400 includes one or more processor(s) 402 (e.g., microprocessors, controllers, coprocessors, etc.), input/output (I/O) interfaces 404 for the input and/or output of data, and user input devices 406. The processor(s) 402 process various instructions to control the operation of the computing device 400, while the input/output interfaces 404 provide a mechanism for the computing device 400 to communicate with other electronic and computing devices. The user input devices 406 may include a keyboard, mouse, pointing device, and/or other mechanisms to interact with, and to input information to the computing device 400.

The input/output interfaces 404 may include serial, parallel, and/or network interfaces. A network interface allows devices coupled to a common data communication network to communicate information with the computing device 400. Similarly, a communication interface, such as a serial and/or parallel interface, a universal serial bus (USB) interface, an Ethernet interface, an Institute of Electrical & Electronics Engineers (IEEE) 802.11 interface, and/or any combination of wireless or wired communication interfaces provides a data communication path directly (or through intermediate computing device(s) or network component(s)) between the computing device 400 and another electronic or computing device.

The computing device 400 may also include a volatile memory 408 and/or nonvolatile memory 410 (such as discussed with reference to FIG. 2), which may provide data storage mechanisms for the computing device 400. Any number and combination of memory and storage devices may be connected with, or implemented within, the computing device 400. Although not shown, a system bus may connect the various components within the computing device 400. Data may be transferred to/from memory (e.g., the memories 408 and 410) through a memory controller 412.

The computing device 400 may also include one or more application program(s) 414 and an operating system 416 which may be stored in volatile/nonvolatile memory (e.g., the memory 408 or 410) and executed on the processor(s) 402 to provide a runtime environment in which the application program(s) 414 may run or execute. The computing device 400 may also include an integrated display device 418, e.g., in embodiments where the computing device 400 is included in a suitable device, such as a PDA, a cellular phone, a digital camera, or other portable/mobile computing devices.

Some embodiments discussed herein (such as those discussed with reference to FIGS. 1-4) may include various operations. These operations may be performed by hardware, software, firmware, and/or combinations thereof. Also, these operations may be embodied in machine-executable instructions, which are in turn utilized to cause a general-purpose or special-purpose processor, or logic circuits programmed with the instructions to perform the operations.

Moreover, some embodiments may be provided as computer program products, which may include a machine-readable or computer-readable medium having stored thereon instructions used to program a computer (or other electronic devices) to perform a process discussed herein. The machine-readable medium may include, but is not limited to, those discussed with reference to memories 210, 212, 408, and/or 410, such as floppy diskettes, hard disk, optical disks, CD-ROMs, and magneto-optical disks, ROMs, RAMs, EPROMs, EEPROMs, magnetic or optical cards, flash memory, or other suitable types of media or machine-readable media that is capable of storing electronic instructions and/or data.

Additionally, some embodiments discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method comprising:
transmitting to a display device a test signal in accordance with a selected video standard;
analyzing one or more signals transmitted by the display device in response to the test signal; and
determining whether the selected video standard is a correct video standard for the display device.

2. The method of claim 1, further comprising:
transmitting to the display device a test signal in accordance with a different video standard if the selected video standard is an incorrect video standard for the display device; and
determining whether the different video standard is the correct video standard for the display device.

3. The method of claim 1, wherein analyzing the one or more signals comprises analyzing one or more of a normalized histogram, a frequency response, and a contrast of the one or more signals transmitted by the display device.

4. The method of claim 1, further comprising instructing a user to point an image capture device towards the display device prior to transmitting the test signal.

5. The method of claim 1, further comprising capturing the one or more signals transmitted by the display device.

6. The method of claim 1, wherein the selected video standard is one of the NTSC, PAL, and SECAM video standard.

7. The method of claim 1, wherein analyzing the one or more signals transmitted by the display device comprises comparing the one or more signals with the test signal.

8. The method of claim 1, further comprising, prior to transmitting the test signal:
firing a strobe to get a user's attention; and
capturing one or more images to determine whether an image capture device is pointed towards the display device.

9. An apparatus comprising:
a signal generator to transmit a test signal to a display device in accordance with a selected video standard;
one or more processors to:
analyze one or more signals transmitted by the display device in response to the test signal; and
determine whether the selected video standard is a correct video standard for the display device.

10. The apparatus of claim 9, wherein the one or more processors direct the signal generator to transmit the test signal to the display device.

11. The apparatus of claim 10, wherein the one or more processors direct the signal generator to transmit the test signal to the display device in accordance with a different video standard if the selected video standard is an incorrect video standard setting for the display device.

12. The apparatus of claim 9, further comprising a sensor to capture the signals transmitted by the display device.

13. The apparatus of claim 12, wherein the sensor is one of a CCD and a CMOS sensor.

14. The apparatus of claim 9, further comprising one or more of a volatile memory and a nonvolatile memory.

15. The apparatus of claim 14, wherein the nonvolatile memory comprises one or more of a ROM, an EPROM, an EEPROM, a CD-ROM, a DVD, a floppy disk, a tape, and a hard drive.

16. The apparatus of claim 14, wherein the volatile memory comprises one or more of RAM, DRAM, SRAM, and SDRAM.

17. The apparatus of claim 9, wherein the apparatus is one or more of a digital camera, a PDA, a cellular phone, an MP3 player, an MPEG4 player, and combinations thereof.

18. An apparatus comprising:
means for transmitting a test signal to a display device in accordance with a selected video standard;
means for analyzing one or more signals transmitted by the display device in response to the test signal; and
means for determining whether the selected video standard is a correct video standard for the display device.

19. The apparatus of claim 18, further comprising means for instructing a user to point an image capture device towards the display device prior to transmitting the test signal.

20. The apparatus of claim 18, further comprising means for storing data.

21. One or more computer-readable media having instructions stored thereon that, when executed, direct a machine to perform acts comprising:
transmitting a test signal to a display device in accordance with a selected video standard;
analyzing one or more signals transmitted by the display device; and
determining whether the selected video standard is a correct video standard for the display device.

22. The one or more computer-readable media of claim 21 having instructions stored thereon that, when executed, direct the machine to perform additional acts comprising:
transmitting the test signal to the display device in accordance with a different video standard if the selected video standard is an incorrect video standard for the display device; and
determining whether the different video standard is the correct video standard for the display device.

23. The one or more computer-readable media of claim 21 having instructions stored thereon that, when executed, the act of analyzing the one or more signals comprises analyzing one or more of a normalized histogram, a frequency response, or a contrast of the one or more signals transmitted by the display device.

24. The one or more computer-readable media of claim 21 having instructions stored thereon that, when executed, direct the machine to perform additional acts comprising instructing a user to point an image capture device towards the display device prior to transmitting the test signal.
